(19) United States
(12) Patent Application Publication
(10) Pub. No.: US 2012/0204744 A1
(43) Pub. Date: Aug. 16, 2012

(54) ROTARY SCREEN PRINTING DEVICE AND METHOD

(75) Inventor: Erhard Herbert Glöckner, Eibelstadt (DE)

(73) Assignee: Zyrus Beteiligungsgesellschaft MBH & Co. Patente I KG, Schönefeld/Waltersdorf (DE)

(21) Appl. No.: 13/390,196

(22) PCT Filed: Aug. 16, 2010
(86) PCT No.: PCT/EP2010/005016

§ 371 Date: Apr. 27, 2012

(30) Foreign Application Priority Data
Aug. 14, 2009 (DE) 10 2009 037 332.2

(51) Int. Cl. B41F 15/04; B41M 1/12; B05C 17/04

(52) U.S. Cl. 101/115; 101/123; 101/129

(57) ABSTRACT

A rotary screen printing device includes a printing cylinder rotatably mounted about a printing cylinder axis. A cylinder jacket of the printing cylinder is formed at least in areas by a printing screen. An impression cylinder is rotatably mounted about an impression cylinder axis. A squeegee is movable relative to the cylinder jacket of the printing cylinder. The squeegee is arranged at least partly inside the printing cylinder for pressing printing ink through the printing screen onto a substrate to be printed. At least one adjustment device is provided for adjusting a distance between the printing cylinder axis and the impression cylinder axis or a radius of the printing cylinder or of the impression cylinder.

### CROSS-REFERENCE TO RELATED APPLICATIONS

This application is a Section 371 of International Application No. PCT/EP2010/005016, filed Aug. 16, 2010, which was published in the German language on Feb. 17, 2011, under International Publication No. WO 2011/018243 A1 and the disclosure of which is incorporated herein by reference.

### BACKGROUND OF THE INVENTION

The present invention relates generally to a rotary screen printing device including a printing cylinder rotatably mounted about a printing cylinder axis, a cylinder jacket of which is formed at least in areas by a printing screen. An impression cylinder is rotatably mounted about an impression cylinder axis. A squeegee is movable relative to the cylinder jacket of the printing cylinder arranged at least partly inside the printing cylinder for pressing printing ink through the printing screen onto a substrate to be printed. The present invention moreover relates to a use of a rotary screen printing device and a rotary screen printing method.

With rotary screen printing machines, printing ink filled into a printing cylinder provided with a printing screen is applied to the material to be printed via the printing cylinder. In doing so, a squeegee arranged inside the printing cylinder usually not rotating together with the printing cylinder rotationally presses the printing ink through the meshes of the printing screen by the rotation of the printing cylinder. The material to be printed is at the same time taken up by a likewise rotating impression roller. The material to be printed is often not provided as continuous webs but rather single sheets which hence have to be kept fixed on the impression cylinder during the printing process. Gripper bars provided on the impression cylinder are described in the prior art for this purpose (see e.g., DE 199 49 099 C2).

A generic rotary screen printing device, for instance, may be derived from DE 199 49 099 C2 or DE 102 32 254 B4.

EP 072 38 64 B1 describes a rotary screen printing machine for sheet printing comprising a form cylinder which carries a screen printing stencil, a printing cylinder which has at least one cylinder groove and forms the printing gap with the form cylinder, and a squeegee which can be radially adjusted inside the form cylinder and which is installed in the region of the printing gap and pressed against the inside of the screen printing stencil during a printing operation. The printing cylinder is provided with sheet grippers in each cylinder groove which, in their closed position, do not project beyond the printing surface of the printing cylinder. The adjustable squeegee and an actuating mechanism controlling the squeegee are constructed and arranged for adjusting the squeegee into a position of rest lifted off from the inside of the rotary screen printing stencil when the open region of the cylinder groove of the printing cylinder passes the region of the printing gap.

EP 8 791 45 B1 shows a rotary screen printing machine for printing products or sheet-type material, wherein the rotary screen printing machine comprises a main frame on which at least one screen printing unit is mounted. The screen printing unit includes a stencil, a stencil holder, drive means for rotatably driving the stencil, and a squeegee as well as a squeegee suspension, an impression roller and a printing paste supply system. The stencil, stencil holder, squeegee, squeegee suspension and printing paste supply system are accommodated in a subframe which is movable in the transverse direction relative to the main frame of the printing machine.

DE 102 322 54 B4 describes a rotary screen printing machine comprising a printing cylinder rotatably mounted about a printing cylinder axis, the cylinder jacket of which is at least partly formed by a printing screen. A squeegee is arranged inside the printing cylinder, fastened to a squeegee holder and extending parallel to the printing cylinder axis exerts pressure on an ink reservoir in the rotational direction of the printing cylinder and presses printing ink supplied prior to the squeegee from the inside of the printing cylinder through the printing screen onto a material to be printed. In the rotational direction prior to the squeegee, an ink supply connected to the ink reservoir and extending parallel to the squeegee is arranged with a plurality of ink outlet openings, wherein the ink outlet openings are arranged directly prior to a squeegee tip facing the printing screen and release the ink substantially in points prior to the squeegee via at least one control valve controlled as a function of a respective rotational position of the printing screen.

The prior art rotary screen printing device described by FIGS. 1 and 2 may principally be the basis of the rotary screen printing device according to a preferred embodiment of the present invention, wherein additions and deviations will be explained hereinafter.

The rotary screen printing device depicted in FIG. 1 is configured for printing a substrate 2 to be printed in the form of single sheets provided in a magazine 1. The path of the substrate 2 (in the present case, the substrate is formed specifically in the form of single sheets) through the rotary screen printing device is marked by arrows. First, the individual substrates 2 successively reach a rotating impression cylinder 4 via a supply means 3. The impression cylinder 4 has a gripper bar 5 shown in FIG. 2 by means of which the substrate 2 is fixedly clamped to the impression cylinder 4. During rotation, a likewise rotating printing cylinder 6 supported on a machine frame 7 acts upon the substrate 2. After the printing process, the gripper bar 5 releases the now printed substrate 2 and same is dried during its further transport through the rotary screen printing device and ultimately fed to a further processing or sorting.

FIG. 2 shows how a printing screen 8 is deformed under the action of the gripper bar 5 of the impression cylinder 4 during the rolling of the printing cylinder 6 and the impression cylinder 4 atop one another. The representation in FIG. 2 is merely schematic and does not correspond to FIG. 1 with respect to the printing cylinder 6 and impression cylinder 4 arrangements.

The rotary screen printing devices according to the prior art are of comparably poor suitability for complicated, in particular differently patterned print images. The accuracy and reproducibility of the rotary screen printing devices according to the prior art are also regarded as being unsatisfactory.

A squeegee may be realized preferably as in DE 199 49 099 C2 and interact with the corresponding rotary screen printing device such as is described in DE 199 49 099 C2 on the basis of FIGS. 3-5 in particular.

### BRIEF SUMMARY OF THE INVENTION

It is a task of a preferred embodiment of the present invention to propose a rotary screen printing device in which complicated and conceivably differently patterned print images can be produced at high accuracy and/or comparably high reproducibility. Preferably, printing at high speed and/or multiple prints shall also be enabled. It is further preferred for safety features to also be printable.

This task is solved by a rotary screen printing device described in detail below and shown herein.

The task is in particular solved by a rotary screen printing device including a printing cylinder rotatably mounted about a printing cylinder axis, the cylinder jacket of which is formed at least in areas by a printing screen, an impression cylinder rotatably mounted about an impression cylinder axis, and a squeegee movable relative to the cylinder jacket of the printing cylinder arranged at least partly inside the printing cylinder for pressing printing ink through the printing screen onto a substrate to be printed.

According to a first preferred aspect of the present invention, an adjustment device for adjusting a distance between the printing cylinder axis and the impression cylinder axis and/or for adjusting a radius of the printing cylinder and/or of the impression cylinder is provided. This for example allows the print image to be adapted to varying properties of the substrate such as an already previously printed print image, for example. An adjustability of the distance between the printing cylinder axis and the impression cylinder axis, respectively the radius of the printing cylinder and/or impression cylinder, allows the effective circumference of the printing cylinder and/or impression cylinder, and thus the printing length, to be varied. The print image can thus be varied whereby more complex patterns are made possible. Preferably, the distance between the printing cylinder axis and the impression cylinder axis is varied radially. As an alternative or in addition, however, the distance can also be varied tangentially. The distance or the radii can preferably be adjusted continuously and/or in discrete steps. It is advantageous for the adjustment device to be lockable by a locking means.

According to a second preferred aspect of the present invention, as an alternative or in addition to providing an adjustment device for adjusting the distance, the impression cylinder can be made at least partly of rubber. Such a cylinder can be configured for example analogously to a rubber cylinder as is known from offset or gravure printing. In combination with the adjusting of the distance between the printing cylinder axis and the impression cylinder axis, the effective circumference, respectively the printing length, can thus be varied in a particularly simple manner, whereby the print image can be varied.

As an alternative or in addition to providing an adjustment device for adjusting the distance, a control means is provided according to a third preferred aspect of the present invention for controlling the position and/or orientation and/or translational and/or rotational speed and/or geometric shape of the squeegee. This allows, for instance, only small areas of the printing screen or a plurality of areas to be squeegeed per revolution. To this end, the prior art required in each case the exchanging of a curve guidance in the printing cylinder, which resulted in considerable retooling costs, respectively loss of time.

As an alternative or in addition to providing an adjustment device for adjusting the distance, the printing cylinder according to a fourth preferred aspect of the present invention includes a plurality of ink chambers, e.g., for different colors, wherein the ink supply of at least one or each color to be supplied can be controlled preferably via an electronic control. At least two squeegees are preferably provided, respectively at least one squeegee is divided into corresponding partial squeegees. This allows print images arranged side by side to be printed with different colors in one printing operation.

Preferably, the ink supply is controllable via an electronic control as a function of ink consumption. Corresponding consumption measuring devices can be provided for this purpose. The electronic control can be provided separately or be comprised as part of a central control unit of the rotary screen printing device. Different print motifs can thus be produced as a function of one single ink.

In a preferred further development of the present invention, the rotary screen printing device is configured for printing substrates with a plurality of print images arranged side by side.

At least one controllable drive can be configured for controlling the position and/or orientation and/or translational and/or rotational speed and/or geometric shape of the squeegee. The control means may in this case in particular comprise control programs e.g. stored in a storage means such as a memory chip or a magnetic memory (e.g., magnetic memory card). The controllable drive is preferably a linear drive.

Further preferred is for the drive to be controllable and/or programmable via a central rotary screen printing device control.

The distance between the printing cylinder axis and the impression cylinder axis may also be manually adjustable, for example. Alternatively, the section may also be automatically adjustable, e.g., via a control, in particular the central rotary screen printing device control. In this respect as well, control programs provided on a storage means may be used.

In a specific preferred configuration of the present invention, a gripper bar is provided on the impression cylinder so as to fix and/or position the substrate to be printed. Moreover, at least one electronically drivable actuator, in particular a micro-actuator, may be configured so as to vary the positioning of the substrate particularly during the printing process to adjust the registration and/or positioning of the print image on the substrate. The positioning may be performed manually or automatically. By operating the micro-actuators during the printing process, registration and positioning of the print image may likewise be performed during the printing process using particularly simple means.

In a preferred configuration of the present invention, the adjusting of the registration and/or positioning of the print image on the substrate relative to a predefined substrate edge and/or already printed print images and/or in particular optoelectronic reference marks may be performed electronically, in particular by means of optoelectronic components being provided such as photodiodes and/or CCD cameras and/or MOS cameras.

Preferably, the optoelectronic component(s) for analyzing the print image on the substrate is (are) formed in an outlet of the rotary screen printing device.

The task is independently solved by the use of a rotary screen printing device, in particular of the type described above, for the printing of substrate sheets and/or roll-shaped substrates, wherein the substrate sheets/substrates are substrate sheets/substrates printed by means of offset printing and/or gravure printing and/or flexographic printing. As an alternative or in addition, a rotary screen printing device can also be used according to the invention to print a plurality of pages arranged side by side.

The task is independently solved by a method for printing substrate sheets and/or roll-shaped substrates using a rotary screen printing device in particular of the type described above, wherein the substrate sheets/substrates are substrate sheets printed by means of offset printing and/or gravure printing and/or flexographic printing, and wherein positioning of the rotary screen print image, in particular during the printing process, is performed in relation to the already previously printed image of the offset printing and/or gravure printing and/or flexographic printing.

With this method as well, positioning may be performed preferably by means of the optoelectronic components described above.

According to a further independent aspect of the present invention, the task is solved by a method comprising the steps of: providing a rotary screen printing device comprising a printing cylinder rotatably mounted about a printing cylinder axis, the cylinder jacket of which is formed at least in areas by a printing screen, an impression cylinder rotatably mounted about an impression cylinder axis, and a squeegee movable relative to the cylinder jacket of the printing cylinder arranged at least partly inside the printing cylinder for pressing printing ink through the printing screen onto a substrate to be printed; and adjusting a distance between the printing cylinder axis and the impression cylinder axis, e.g., during operation. Such a method principally exhibits the same advantages as the rotary screen printing device described above.

It is preferred to provide an impression cylinder which is at least partly made of rubber. The rubber proportion may e.g. be 10% or preferably 30%, further preferred 70%, in particular 90%.

In a specific configuration of a preferred method of the present invention, the position and/or orientation and/or translational and/or rotational speed and/or geometric shape of the squeegee is controlled as a function of default values and/or previously measured substrate parameters. A control which is contingent on a print image already previously applied to the substrate is equally conceivable. Such a method employs a component in the form of the squeegee which is already an elementary part of a rotary screen printing device for varying the print image. This allows the variability of the method to be increased with simple means without any further constructional parts.

Preferably, a control means is programmed to control the position and/or orientation and/or translational and/or rotational speed and/or geometric shape of the squeegee. In a preferred configuration of the present invention, the ink supply of at least one or each color to be supplied is controlled electronically and an electronic control programmed accordingly as need be.

In a specific configuration of the present invention, the ink supply is controlled as a function of the ink consumption.

The distance between the printing cylinder axis and the impression cylinder axis is varied manually, in particular during operation, respectively printing. Alternatively, the distance may also be varied automatically, particularly by a control means, respectively the central rotary screen printing control means.

Further preferred embodiments of the present will result from the dependent claims.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

The invention will be described below also with respect to further features and advantages on the basis of exemplary embodiments explained in more detail by means of the figures. In the drawings:

FIG. 1 is a schematic side view of a rotary screen printing machine according to the prior art;

FIG. 2 is a schematic view of a printing cylinder and an impression cylinder of the rotary screen printing device according to the prior art;

FIG. 3 is a schematic view of a printing cylinder and impression cylinder of a rotary screen printing machine according to a preferred embodiment of the present invention in a first position;

FIG. 4 is a schematic view of the printing cylinder and impression cylinder shown in FIG. 3 in a second position;

FIG. 5 is a schematic view of a printing cylinder according to a preferred embodiment of the present invention; and

FIG. 6 is a schematic section view of the printing cylinder shown in FIG. 5 along the VI-VI cutting line in FIG. 5.

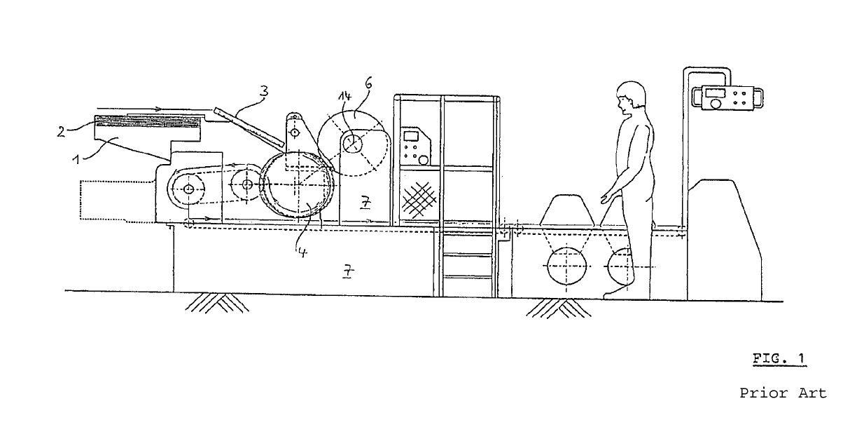

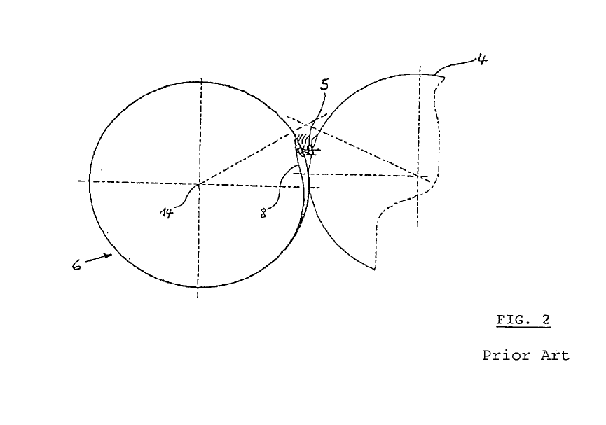

### DETAILED DESCRIPTION OF THE INVENTION

Certain terminology is used in the following description for convenience only and is not limiting. Unless specifically set forth herein, the terms “a,” “an” and “the” are not limited to one element, but instead should be read as meaning “at least one.” The terminology includes the words noted above, derivatives thereof and words of similar import. The same reference numerals will be used in the following description for identical parts or parts of identical effect.

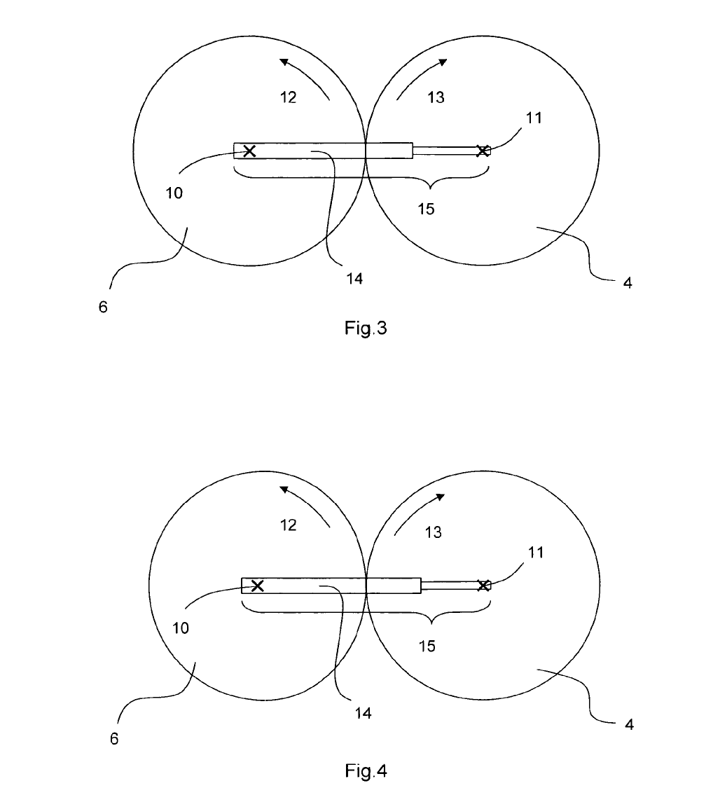

Referring to the drawings in detail, wherein like numerals indicate like elements throughout the several views, FIG. 3 shows a printing cylinder 6 which is preferably rotatably mounted about a printing cylinder axis 10, and an impression cylinder 4 which is rotatably mounted about an impression cylinder axis 11. Printing cylinder 6 and impression cylinder 4 contrarotate in the direction of arrows 12, 13.

Preferably, an adjustment device 14 is provided enabling the adjusting of a distance 15 between the printing cylinder axis 10 and the impression cylinder axis 11. Just as an example, the adjustment device 14 may be of a telescope-like construction. Adjusting may be performed manually, hydraulically or by means of an electric drive. Adjusting preferably can be controlled electronically, wherein a control means (not shown) can be programmed correspondingly. Preferably, a central control unit is provided for this purpose which correspondingly controls one or more rotary screen printing devices. This may also occur via a network such as the internet or an intranet, for example. The control can be wire-based or else wireless, for example by infrared or radio.

FIG. 4 shows the printing cylinder 6 and impression cylinder 4 from FIG. 3, however with the respective distance 15 between the printing cylinder axis 10 and the impression cylinder axis 11 being shortened. This causes the printing cylinder 6 and/or impression cylinder 4 to be deformed correspondingly so that the print length increases. This also changes the printing cylinder 6 and/or impression cylinder 4 contact pressure on the substrate (not shown). This thus creates a possibility of being able to achieve a variation of the print image by simple means.

The varying of the distance 15 can be performed continuously or else discretely, for example. It is advantageous for the adjustment device to be correspondingly lockable by a locking means. It can for example be provided for the locking means to enable locking in at least 10, preferably at least 100 discrete locking positions. Preferably, the distance can be controlled by the control means (not shown in the figures), wherein parameters of the substrate or measured values obtained by respective measuring means (not shown) during printing are used for controlling the distance 15.

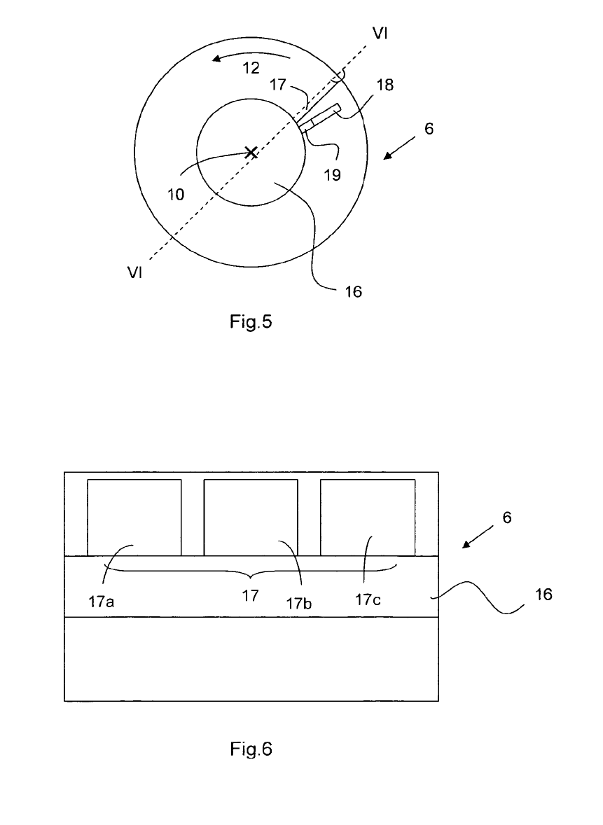

FIG. 5 shows a schematic view of the printing cylinder 6 in a preferred embodiment. A cylinder-shaped squeegee holder 16 is located inside the printing cylinder 6 on which a squeegee 17 which is divided into three partial squeegees 17a, 17b, 17c (according to FIG. 6) is disposed. FIG. 6 shows in this case a section of the printing cylinder 6 from FIG. 5 along the VI-VI cutting line.

An ink supply 18 can furthermore be seen in FIG. 5 which applies printing ink from an ink chamber 19 onto the inner wall of the printing cylinder 6 (respectively a printing screen, not shown). In each case, preferably three (or two or an overall plurality of) separate ink chambers 19 (not shown in the figures) as well as corresponding ink supplies 18 are provided in total (not shown in the figures). The ink supply can be electronically regulated by a central control or else by a separate control. When a plurality of squeegees is provided, a plurality of print images arranged side by side can be printed in different colors. Corresponding measuring units (not shown) may be provided which measure the ink consumption and accordingly control the ink supply electronically via a control.

Preferably, the squeegee 17, respectively the partial squeegees 17a-17d as the case may be, can each be separately moved translationally and/or radially by a control, respectively the central control, wherein doing so ensues in a particularly advantageous manner during the printing process. Such an option for displacement is also advantageous when a squeegee 17 is provided that is not divided into partial squeegees.

Here as well, it is conceivable for a displacement to be performed continuously and/or discretely. Corresponding locking means may be provided (not shown in the figures). An axial displacement, for example, allows only small areas in the printing cylinder to be squeegeed.

Preferably, the squeegee 17 respectively the squeegee holder 16 is not rigidly but rotatably supported so that a plurality of areas of the printing cylinder 6 can be squeegeed per revolution.

It should be emphasized at this point that all of the components described above taken individually and in any combination, in particular the details illustrated in the drawings, are claimed as being essential to the invention. The skilled person will be familiar with modifications thereof.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-25. (canceled)

26. A rotary screen printing device, comprising:
a printing cylinder rotatably mounted about a printing cylinder axis, a cylinder jacket of the printing cylinder is formed at least in areas by a printing screen;
an impression cylinder rotatably mounted about an impression cylinder axis;
a squeegee movable relative to the cylinder jacket of the printing cylinder, the squeegee being arranged at least partly inside the printing cylinder for pressing printing ink through the printing screen onto a substrate to be printed; and
at least one adjustment device for adjusting at least one of:
a distance between the printing cylinder axis and the impression cylinder axis;
a radius of the printing cylinder; and
a radius of the impression cylinder.

27. The rotary screen printing device according to claim 26, wherein the impression cylinder is at least partly made of rubber.

28. The rotary screen printing device according to claim 26, wherein a control means for controlling at least one of the position, the orientation, the translational speed, the rotational speed, and the geometric shape of the squeegee.

29. The rotary screen printing device according to claim 26, wherein the printing cylinder comprises a plurality of ink chambers for different colors, wherein an ink supply of at least one color to be supplied is preferably controllable by means of an electronic control.

30. The rotary screen printing device according to claim 29, wherein at least two squeegees are provided.

31. The rotary screen printing device according to claim 29, wherein the ink supply is controllable via the electronic control as a function of ink consumption.

32. The rotary screen printing device according to claim 29, wherein the rotary screen printing device is configured for printing substrates with a plurality of print images arranged side by side.

33. The rotary screen printing device according claim 28, wherein at least one controllable drive is configured for controlling.

34. The rotary screen printing device according to claim 28, wherein the control means comprises control programs for controlling.

35. The rotary screen printing device according to claim 33, wherein the controllable drive is a linear drive.

36. The rotary screen printing device according to claim 33, wherein the controllable drive is controllable or programmable via a central control.

37. The rotary screen printing device according to claim 26, wherein the distance between the printing cylinder axis and the impression cylinder axis is manually adjustable.

38. The rotary screen printing device according to claim 26, wherein the distance between the printing cylinder axis and the impression cylinder axis is automatically adjustable by a preferably central control.

39. The rotary screen printing device according to claim 26, further comprising:
a gripper bar provided on the impression cylinder to fix or position the substrate.

40. The rotary screen printing device according to claim 26, further comprising:
at least one electronically drivable actuator being configured for adjusting a positioning of the substrate during the printing process for adjusting a registration or positioning of a print image on the substrate.

41. The rotary screen printing device according to claim 40, wherein the adjusting of the registration or positioning of the print image on the substrate relative to a predefined substrate edge or at least one already printed print image or optoelectronic reference marks is performed electronically by means of optoelectronic components.

42. The rotary screen printing device according to claim 41, the optoelectronic components for analyzing the print image on the substrate are formed in an outlet of the rotary screen printing device.

43. A method of using a rotary screen printing device according to claim 26, wherein the substrate is substrate sheets printed by means of offset printing, gravure printing, or flexographic printing.

44. The method according to claim 43, wherein the rotary screen printing device is used for printing a plurality of the substrate sheets in a side by side arrangement.

45. A rotary screen printing method according to claim 43, the method comprising:
rotatably mounting the printing cylinder rotatably mounted about the printing cylinder axis;
providing the cylinder jacket formed at least in areas by the printing screen;
rotatably mounting the impression cylinder about the impression cylinder axis;
providing the squeegee movable relative to the cylinder jacket of the printing cylinder arranged at least partly inside the printing cylinder for pressing printing ink through the printing screen onto the substrate to be printed; and
adjusting the distance between the printing cylinder axis and the impression cylinder axis during the printing process.

46. The rotary screen printing method according to claim 45, wherein the squeegee is controlled as a function of default values or previously measured substrate parameters with respect to position, the orientation, the translational speed, the rotational speed, or the geometric shape of the squeegee.

47. The method according to claim 45, wherein an ink supply is controlled as a function of ink consumption via an electronic control.

48. The rotary screen printing method according to claim 45, wherein the distance between the printing cylinder axis and the impression cylinder axis is adjusted manually.

49. The rotary screen printing method according to claim 45, wherein the distance between the printing cylinder axis and the impression cylinder axis is adjusted automatically by a central control means.
